(19) United States
(12) Patent Application Publication
(10) Pub. No.: US 2025/0387928 A1
(43) Pub. Date: Dec. 25, 2025

(54) JOINT STRUCTURE FOR ROBOT INCLUDING MOVABLE ROTATION AXIS

(71) Applicant: MYONGJI UNIVERSITY INDUSTRY AND ACADEMIA COOPERATION FOUNDATION, Yongin-si (KR)

(72) Inventors: Bum Joo LEE, Yongin-si (KR); Kwon Hui LEE, Cheongju-si (KR)

(21) Appl. No.: 18/938,998

(22) Filed: Nov. 6, 2024

(30) Foreign Application Priority Data
Jun. 20, 2024 (KR) 10-2024-0080141

(51) Int. Cl. B25J 17/02

(52) U.S. Cl. CPC B25J 17/0241

(57) ABSTRACT

A joint structure for a robot of which a rotation axis is movable is disclosed. The joint structure includes a guide rail, a slider configured to contact with an external side of the guide rail and a driving member configured to move the slider along the guide rail. Here, the guide rail has a curved shape not a circular shape to move a rotation axis of the joint structure.

### CROSS-REFERENCE TO RELATED APPLICATIONS

This application claims the benefit of priority under 35 U.S.C. § 119(a) to Korean Patent Application 10-2024-0080141, filed with the Korean Intellectual Property Office on Jun. 20, 2024, the disclosure of which is hereby incorporated by reference in its entirety.

### TECHNICAL FIELD

The disclosure relates to a joint structure for a robot of which a rotation axis is movable.

### BACKGROUND ART

FIG. 1 is a view illustrating a structure of conventional robot.

As shown in FIG. 1, a rotation axis of a joint of a strength augmentation robot is fixed. As a result, pressure is applied to the ligaments or muscles of a body of a wearer of the robot when the wearer bends a joint, which can cause injury to the joint.

### SUMMARY

The disclosure is to provide a joint structure for a robot of which a rotation axis is movable.

A joint structure according to an embodiment of the disclosure includes a guide rail; a slider configured to contact with an external side of the guide rail; and a driving member configured to move the slider along the guide rail. Here, the guide rail has a curved shape not a circular shape to move a rotation axis of the joint structure.

A joint structure according to another embodiment of the disclosure includes a driving supporting member; spaces formed on the driving supporting member; and pins of which parts are inserted in the spaces. Here, at least one of the pins is movable according to shape of a joint of a user.

In a joint structure of a robot wearable by a user according to still another embodiment of the disclosure, shape of at least part of the joint structure is changed according to a shape of a joint of the user, and a rotation axis of the joint structure is movable in response to moving of the user when the user moves.

A joint structure according to still another embodiment of the disclosure includes a rotation axis moving path member. Here, a rotation axis of the joint structure moves through the rotation axis moving path member, and shape of the rotation axis moving path member is adaptively changed according to shape of a joint of a user.

A joint structure for a robot according to the disclosure has a rotation axis which is adaptively changed depending on a moving of a joint, and thus it may not cause injury to a body of a wearer of the robot. Additionally, a rotation axis of conventional exoskeleton robot is fixed, thereby causing injury to the joint of a user. This problem may be solved if the joint structure is employed.

Furthermore, shape of the joint structure is changed according to a shape of the joint of the wearer, and so many users may use the robot without physical strain.

### BRIEF DESCRIPTION OF DRAWINGS

Example embodiments of the present disclosure will become more apparent by describing in detail example embodiments of the present disclosure with reference to the accompanying drawings, in which:

FIG. 1 is a view illustrating a structure of conventional robot;

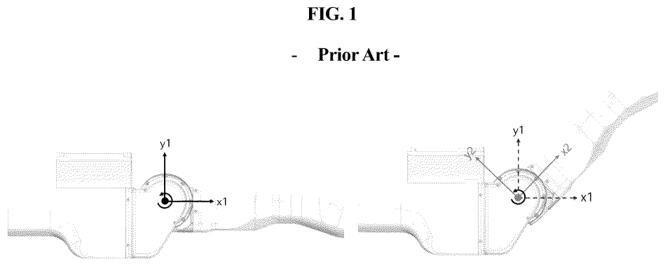

FIG. 2 is a perspective view illustrating a joint structure according to an embodiment of the present disclosure;

FIG. 3 is a view illustrating array of a slider, pins and a guide rail according to an embodiment of the present disclosure;

FIG. 4 is a view illustrating a lower surface of the joint structure in FIG. 2;

FIG. 5 is a perspective view illustrating the joint structure in different view according to an embodiment of the present disclosure; and

FIG. 6 is a view illustrating operation of the joint structure according to an embodiment of the present disclosure.

### DETAILED DESCRIPTION

In the present specification, an expression used in the singular encompasses the expression of the plural, unless it has a clearly different meaning in the context. In the present specification, terms such as “comprising” or “including,” etc., should not be interpreted as meaning that all of the elements or operations are necessarily included. That is, some of the elements or operations may not be included, while other additional elements or operations may be further included. Also, terms such as “unit,” “module,” etc., as used in the present specification may refer to a part for processing at least one function or action and may be implemented as hardware, software, or a combination of hardware and software.

The disclosure relates to a joint structure in which a rotation axis of a joint is movable. As a result, it is possible to realize a robot, e.g. strength augmentation robot which does not put strain on a body of a wearer. Especially, the joint structure of the disclosure may realize the same mechanism as real joint of a person.

Hereinafter, various embodiment of the disclosure will be described in detail with reference to accompanying drawings.

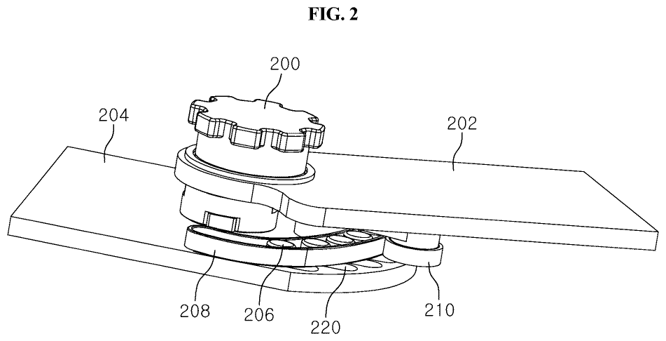

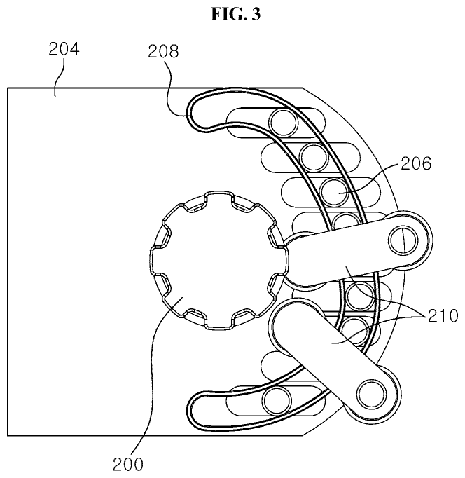

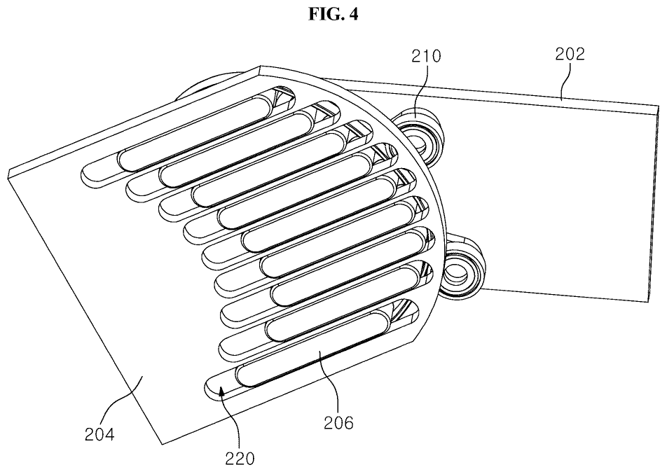

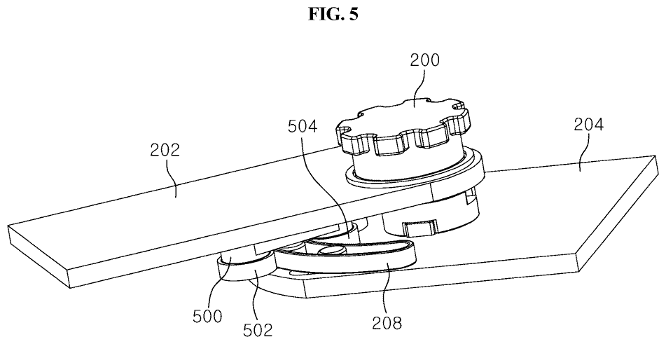

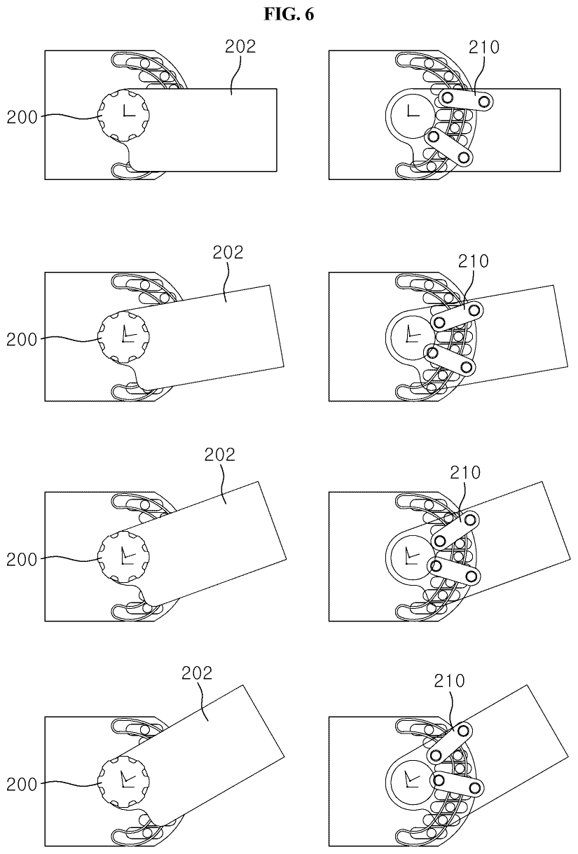

FIG. 2 is a perspective view illustrating a joint structure according to an embodiment of the disclosure, FIG. 3 is a view illustrating array of a slider, pins and a guide rail, FIG. 4 is a view illustrating a lower surface of the joint structure in FIG. 2, FIG. 5 is a perspective view illustrating the joint structure in different view according to an embodiment of the disclosure, and FIG. 6 is a view illustrating operation of the joint structure according to an embodiment of the disclosure.

In FIG. 2, the joint structure of the present embodiment may include a driving member (Oldham coupling) 200, a slider supporting member 202, a driving supporting member 204, pins 206, a guide rail 208 and a slider 210.

The driving member 200 may rotate the slider supporting member 202. For example, the slider supporting member 202 may rotate when a motor (not shown) rotates the driving member 200 while an end part of the slider supporting member 202 is fixed to the driving member 200 as shown in FIG. 2. Here, numerical number 200 is referred to as the driving member in that it operates the slider supporting member 202, but it may become named as a power delivering member because it delivers a power of the motor to the slider supporting member 202.

The slider supporting member 202 may support the slider 210. In view of operation, the slider 210 may move with the slider supporting member 202 while it is supported by the slider supporting member 202. Here, the slider supporting member 202 may be a part corresponding to for example a lower part of an arm.

In an embodiment, the sliders 210 may move along the guide rail 208 while they are supported by the slider supporting member 202. In this time, the slider 210 may rotate properly according to shape of the guide rail 208 as shown in FIG. 6. For this operation, the slider 210 may be combined with a lower part of the slider supporting member 202 in a rotatable manner.

In an embodiment, the slider 210 may include a slider body 500, a first slider leg 502 connected vertically to an end part of the slider body 500 and a second slider leg 504 connected vertically to the other end part of the slider body 500. Here, the slider body 500 may be connected to the lower part of the slider supporting member 202 in a rotatable manner, the first slider leg 502 may be contacted with one side of the guide rail 208, and the second slider leg 504 may be contacted with the other side of the guide rail 208. As a result, the slider 210 moves along the guide rail 208 when the slider supporting member 202 rotates in response to rotation of the driving member 200, the slider 210 rotating adaptively according to the shape of the guide rail 208. That is, the slider 210 may rotate adaptively so that the slider legs 502 and 504 support continuously both sides of the guide rail 208 when the slider 210 moves along the guide rail 208. In another view, the shape of the guide rail 208 may be kept by the slider legs 502 and 504.

In another embodiment, the slider body 500 is combined fixedly with the slider supporting member 202, the slider legs 502 and 504 rotating adaptively depending on the shape of the guide rail 208. For this operation, the slider legs 502 and 504 may be connected to the slider body 500 in a rotatable manner.

The pins 206 may locate in sequence in an internal space of the guide rail 208. Here, the pins 206 may be separated each other.

In an embodiment, holes 220 may be formed on the driving supporting member 204, and lower parts of the pins 206 may be inserted into the holes 220. Here, a size of the hole 220 may be larger than that of the pin 206. This is because the wearer of a robot has different shape of the joint, and thus the pin 206 should be movable according to the shape of the joint. That is, the pin 206 may be inserted into the hole 220 on the driving supporting member 204 inside the guide rail 208 and may move in the hole 220.

In an embodiment, a width of a lower surface of the pin 206 may be larger than that of an upper surface of the pin 206 as shown in FIG. 2 and FIG. 4. This is for moving stably the pin 206.

In another embodiment, a groove may be formed on the driving supporting member 204 and the lower part of the pin 206 may be inserted into the groove.

The guide rail 208 may be disposed on an upper surface of the driving supporting member 204, and pins 206 may locate inside the guide rail 208. Here, the guide rail 208 may have a closed structure to surround the pins 206.

In an embodiment, the guide rail 208 may have a curved shape not a circular shape to change a rotation axis of the joint structure. That is, at least one of distances between the driving member 200 and parts of the guide rail 208 may differ. This is because the convex part of the joint of the wearer of the robot equipped with the joint structure does not have a circular shape, and so the rotation axis of the joint structure should be movable in order not to impose physical strain on the wearer. If the rotation axis of the joint structure is fixed, pressure is applied to the ligaments and muscles when the wearer bends the joint, which can cause injury to the joint.

Accordingly, the guide rail 208 may be embodied with shape not the circular shape, and thus the rotation axis of joint structure changes when the slider 210 moves in response to rotation of the slider supporting member 202 as shown in FIG. 6. In this time, the slider 210 moves along the guide rail 208 with rotating adaptively according to the shape of the guide rail 208 as shown in FIG. 6. In this case, when the wearer of the strength augmentation robot lifts an object, the weight of the object may be fully applied to only the robot, thereby preventing strain on the wearer.

Additionally, the pins 206 may move adaptively in a direction crossing over the guide rail 208 according to shape of the joint of the wearer, and so shape of the guide rail 208 may be changed. In this case, the slider 210 moves along the guide rail 208, and thus the rotation axis of the joint structure is changed depending on the shape of the joint of the wearer.

Briefly, the joint structure of the present embodiment may realize moving of the rotation axis by using the guide rail 208 and adapt to the joint of the wearer through the moving of the pins 206.

In above description, the guide rail 208 and the pins 206 inside the guide rail 208 are used. However, various structures may be employed as long as the rotation axis is movable and corresponds adaptively to the shape of the joint of the wearer.

Particularly, the joint structure may include a rotation axis moving path member for moving the rotation axis, the rotation axis moving path member being changed according to the shape of the joint of the wearer. That is, the rotation axis of the joint structure moves through the rotation axis moving path member, and shape of the rotation axis moving path member may be adaptively changed according to the shape of the joint of the wearer.

Components in the embodiments described above can be easily understood from the perspective of processes. That is, each component can also be understood as an individual process. Likewise, processes in the embodiments described above can be easily understood from the perspective of components.

The embodiments of the disclosure described above are disclosed only for illustrative purposes. A person having ordinary skill in the art would be able to make various modifications, alterations, and additions without departing from the spirit and scope of the disclosure, but it is to be appreciated that such modifications, alterations, and additions are encompassed by the scope of claims set forth below.

1. A joint structure comprising:
a guide rail;
a slider configured to contact with an external side of the guide rail; and
a driving member configured to move the slider along the guide rail,
wherein the guide rail has a curved shape not a circular shape to move a rotation axis of the joint structure.

2. The joint structure of claim 1, wherein a space is formed in the guide rail,
and wherein pins are disposed in sequence along the guide rail in the space, and at least one of distances between parts of the guide rail and the driving member differs.

3. The joint structure of claim 2, wherein each of the pins is movable in a direction crossing over the guide rail,
and wherein the pins move according to a shape of a joint of a wearer of a robot employing the joint structure, and the guide rail surrounds the pins.

4. The joint structure of claim 3, wherein holes are formed on a driving supporting member for supporting the guide rail,
and wherein end parts of the pins locate in the holes, the pins are movable in the holes because a size of the hole is larger than that of the pin, and a shape of the guide rail is changed according as the pins move.

5. The joint structure of claim 1, further comprising:
a driving supporting member configured to support the driving member; and
a slider supporting member configured to rotate according to control of the driving member while it is connected to the driving member,
wherein the guide rail locates on the driving supporting member, the slider supports both sides of the guide rail while it combines with a lower surface of the slider supporting member, and the slider has a structure for rotating adaptively according to a shape of the guide rail when the slider moves along the guide rail.

6. The joint structure of claim 5, wherein the slider includes:
a slider body connected to the slider supporting member in a rotatable manner;
a first slider leg configured to support one side of the guide rail while it is connected to one end part of the slider body; and
a second slider leg configured to support the other side of the guide rail while it is connected to the other end part of the slider body.

7. A joint structure comprising:
a driving supporting member;
spaces formed on the driving supporting member; and
pins of which parts are inserted in the spaces,
wherein at least one of the pins is movable according to a shape of a joint of a user.

8. The joint structure of claim 7, further comprising:
a closed type guide rail configured to surround the pins,
wherein a shape of the guide rail is changed in response to moving of the pin, and the guide rail has a curved shape not a circular shape to move a rotation axis of the joint structure.

9. A joint structure of a robot wearable by a user,
a shape of at least part of the joint structure is changed according to a shape of a joint of the user, and a rotation axis of the joint structure is movable in response to moving of the user when the user moves.

10. The joint structure of claim 9, wherein the part of the joint structure of which shape is changed according to the shape of the joint of the user has a curved shape not a circular shape.

11. A joint structure comprising:
a rotation axis moving path member,
wherein a rotation axis of the joint structure moves through the rotation axis moving path member, and a shape of the rotation axis moving path member is adaptively changed according to a shape of a joint of a user.
